(19) United States
(12) Patent Application Publication
(10) Pub. No.: US 2015/0301164 A1
(43) Pub. Date: Oct. 22, 2015

(54) ACOUSTIC MODULE AND ANTENNA INCORPORATING SAID ACOUSTIC MODULE

(71) Applicant: Thales, Neuilly/Sur/Seine (FR)

(72) Inventor: Eric SERNIT, MOUANS-SARTOUX (FR)

(21) Appl. No.: 14/367,863

(22) PCT Filed: Dec. 17, 2012
(86) PCT No.: PCT/EP2012/075720

§ 371 Date: Jun. 20, 2014

(30) Foreign Application Priority Data
Dec. 23, 2011 (FR) 11/04074

(51) Int. Cl. G01S 7/521; H01Q 1/04; G10K 11/00

(52) U.S. Cl. CPC G01S 7/521; G10K 11/008; H01Q 1/04

(57) ABSTRACT

An acoustic module is provided for an acoustic antenna for receiving submarine waves, produced in the form of a panel of polychloroprene-based rubber incorporating a plurality of longitudinal tubular ducts extending along the length of the rubber panel and being spaced apart along the width of the rubber panel, the longitudinal ducts receiving columns of hydrophones spaced apart lengthwise, the rubber panel also incorporating at least one transverse duct extending along the width of the rubber panel, the longitudinal and transverse ducts being filled with a fluid and the acoustic panel capable of blocking the ducts in a seal-tight manner, the hardness of the rubber and the thickness of the panel being chosen such that the acoustic module exhibits a first degree of freedom in bending about an axis extending lengthwise and a second degree of freedom in bending about an axis extending widthwise.

The present invention relates to the acoustic antennas for receiving submarine waves.

Such antennas are, for example, intended to detect and locate submarine acoustic noise sources. These antennas are intended to work in low and mid-range frequencies. Low or mid-range frequencies should be understood to mean frequencies below 12 kHz. In practice, to obtain good performance levels both in detection and in location, it is necessary to work on a spectrum of low or mid-range frequencies and to have an antenna whose gain is significant in order to obtain a satisfactory signal-to-noise ratio (in many applications, a gain of 20 dB is necessary).

The present invention relates more particularly to the cylindrical sonar antennas placed on submarines and the flank antennas which are installed on the flanks of the submarines.

The cylindrical sonar antennas are conventionally formed by a set of columns of hydrophones produced in the form of rigid elongate modules. These modules are fixed onto the generatrices of a cylinder. As is known, these modules are fixed in a juxtaposed manner by being pressed against a supporting cylinder which is conventionally called “drum”.

These antennas have the drawback of being costly. The fact of having to fix each column of hydrophones onto the supporting cylinder in fact implies significant assembly times and costs.

One aim of the invention is to remedy this drawback.

Moreover, the flank antennas are conventionally formed by a juxtaposition of acoustic modules produced in the form of rectangular panels incorporating surface acoustic sensors and exhibiting a degree of freedom in bending about a transverse axis extending along the width of the panels so as to closely follow the cylindrical form of the submarine.

However, these modules cannot be used to produce cylindrical antennas. To conclude, the flank antennas and the cylindrical antennas are produced by means of very different technologies which induces very significant production costs.

Another aim of the invention is to remedy this drawback.

To this end, the subject of the invention is an acoustic module for an acoustic antenna for receiving submarine waves, produced in the form of a panel of polychloroprene-based rubber, said module incorporating a plurality of longitudinal tubular ducts extending along the length of the rubber panel and being spaced apart along the width of the rubber panel, said longitudinal ducts receiving columns of hydrophones spaced apart lengthwise, said rubber panel also incorporating at least one transverse duct extending along the width of said rubber panel, said longitudinal and transverse ducts being filled with a fluid and said acoustic panel being provided with means for blocking said ducts in a seal-tight manner, the hardness of the rubber and the thickness of the panel being chosen such that the acoustic module exhibits a first degree of freedom in bending about an axis extending lengthwise and a second degree of freedom in bending about an axis extending widthwise.

Advantageously, the transverse duct crosses the longitudinal ducts.

Advantageously, said ducts are filled with a liquid.

Advantageously, the transverse duct conveys electrical connection cables used to establish an electrical link between hydrophones and electrical connection elements arranged at an end of the transverse duct, the electrical connection elements being intended to cooperate with a processing unit for processing the signals from the hydrophones.

Advantageously, a processing unit for processing the signals from the hydrophones at one end of one of said ducts.

Advantageously, the hardness of the rubber, the thickness of the panel and the arrangement of the ducts are chosen such that the acoustic panel can be bent with a first minimum bending radius of between 1 m and 2.5 m about an axis extending along the length of said panel and with a second minimum bending radius of between 1 m and 2.5 m about an axis extending along the width of the panel.

Advantageously, the rubber exhibits a Shore hardness of between 60 and 80 Shores A.

Advantageously, the panel has a thickness of between 5 cm and 15 cm.

Another subject of the invention is an acoustic antenna for receiving submarine waves for passive sonar comprising a set of acoustic modules according to the invention.

In one embodiment, the antenna is tubular.

Advantageously, the antenna is tapered.

Advantageously, the antenna comprises a drum and the acoustic modules bear against said drum.

As a variant, the antenna comprises a bottom ring and a top ring that are coaxial, and in which the acoustic modules are fixed to the bottom and top rings and are arranged in such a way as to form, between the two rings, a tubular self-supporting drum, the panels extending lengthwise between the bottom ring and the top ring.

The tubular antenna can be cylindrical.

In this variant, the acoustic modules are advantageously arranged in such a way that the columns of hydrophones extend along respective generatrices of a single cylinder.

In another embodiment, the acoustic modules are fixed onto the front part of the hull of a submarine.

Advantageously, the acoustic modules block a mouth formed in the front part of the hull of a submarine.

Another subject of the invention is an acoustic antenna for receiving submarine waves, comprising a succession of acoustic modules according to the invention, the modules being mounted to bear against a hull of a submarine, said acoustic modules being arranged in such a way as to extend according to their width substantially parallel to the axis of the submarine.

Other features and advantages of the invention will become apparent on reading the following detailed description, given as a nonlimiting example and with reference to the attached drawings in which:

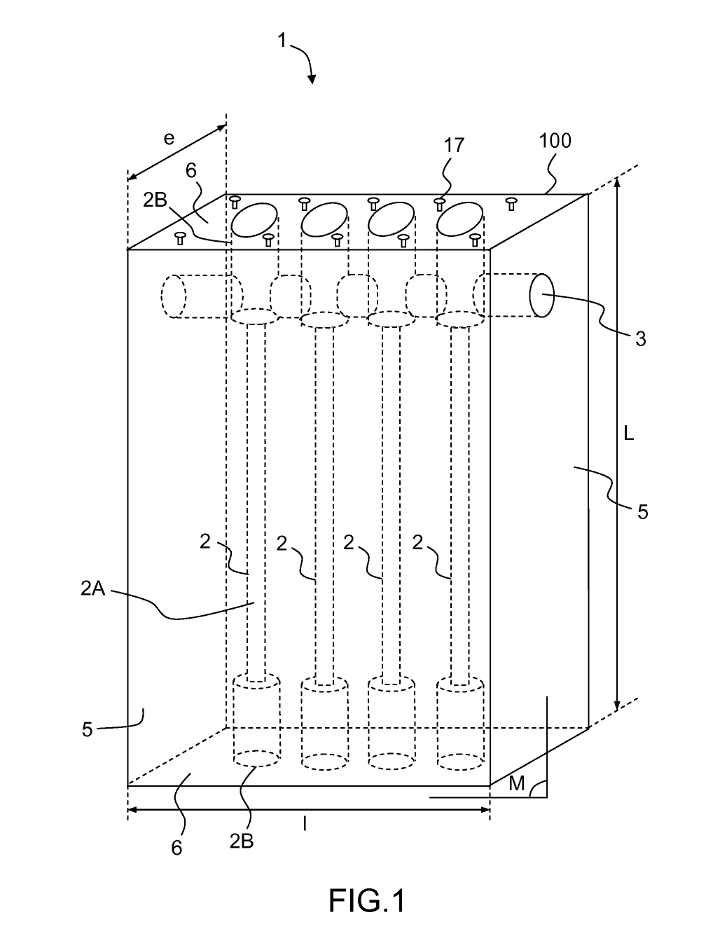

FIG. 1 schematically represents an acoustic module according to the invention,

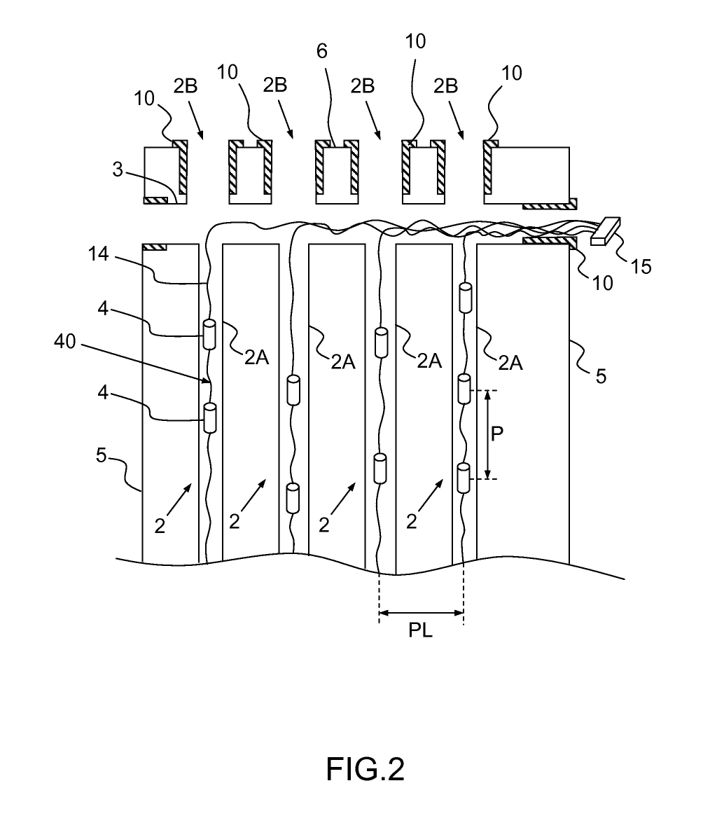

FIG. 2 schematically represents a cross section along a plane M of a portion of an acoustic module according to the invention,

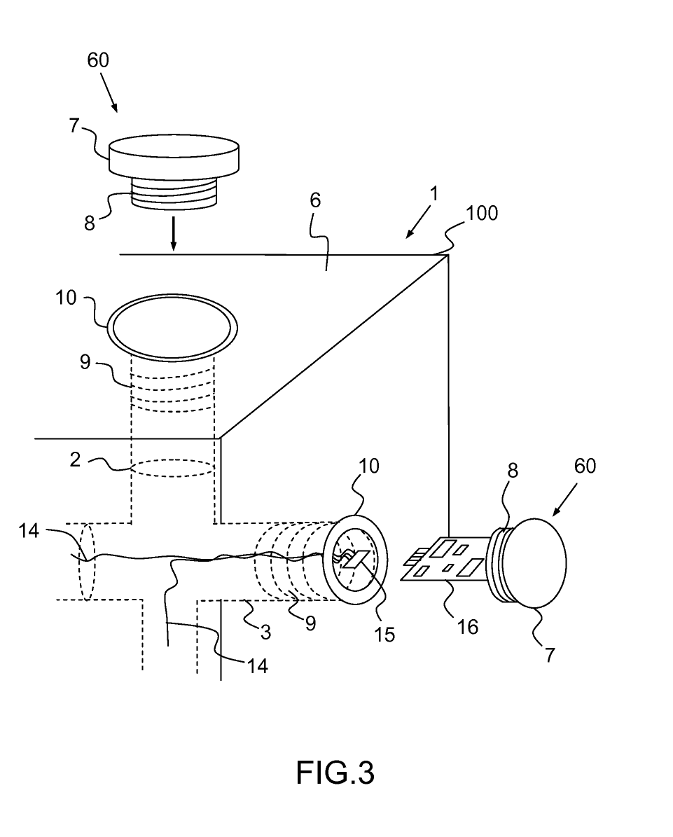

FIG. 3 schematically represents, in perspective, the top right portion of the acoustic module of FIGS. 1 and 2,

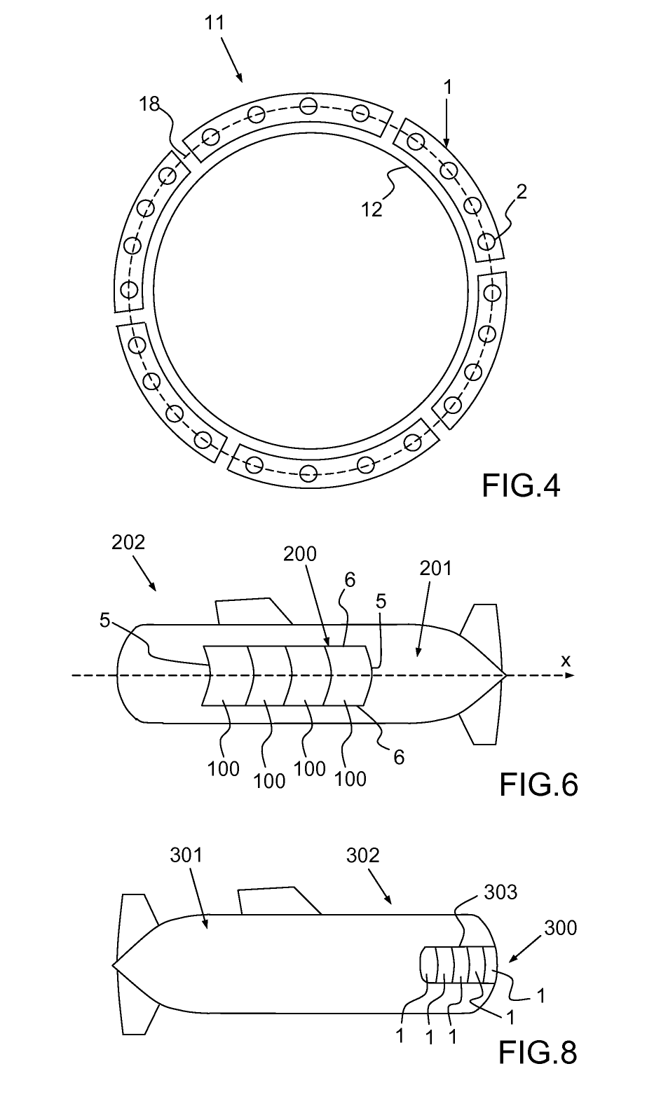

FIG. 4, schematically represents a transverse cross section of a cylindrical antenna for passive sonar according to a first embodiment of the invention,

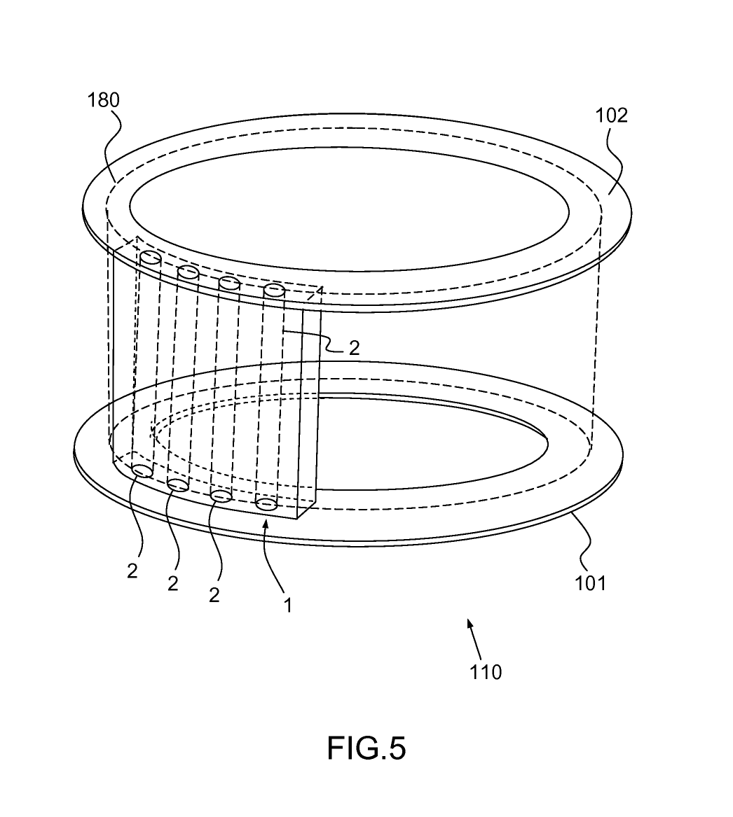

FIG. 5 schematically represents, in perspective, a second embodiment of a cylindrical antenna for passive sonar according to the invention,

FIG. 6 represents a flank antenna according to the invention,

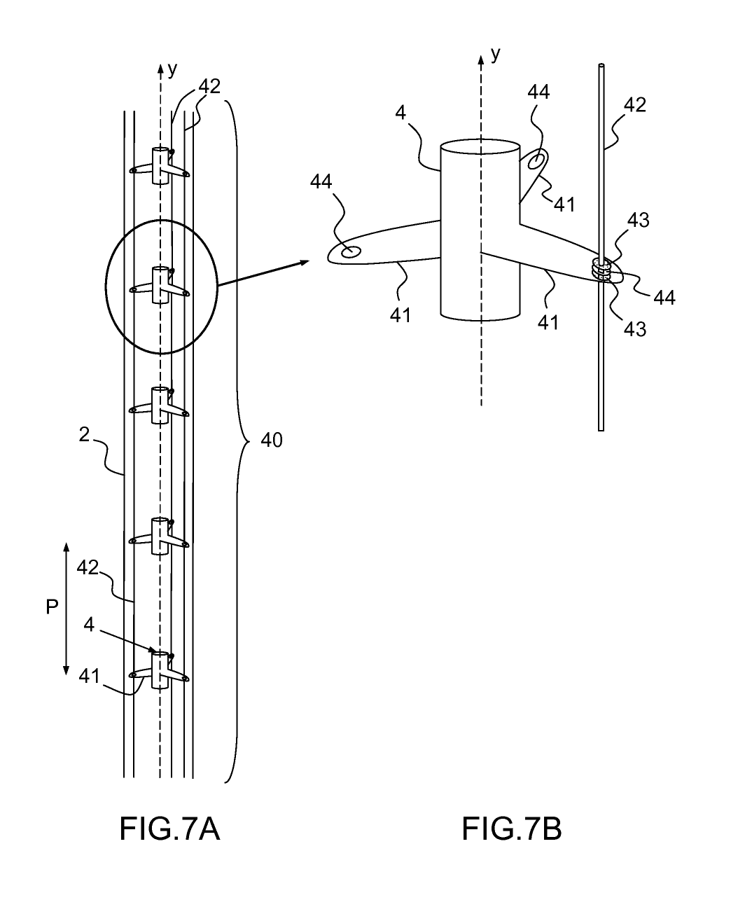

FIG. 7A schematically represents a column of hydrophones extending along an axis corresponding to the axis of the hydrophones that it comprises; FIG. 7B schematically represents, in detail, the content of the bubble represented in FIG. 7A,

FIG. 8 represents a submarine according to the invention.

From one figure to another, the same elements are identified by the same references.

FIG. 1 shows an acoustic module 1 for an antenna for receiving submarine waves according to the invention. This acoustic module 1 takes the form of a panel of polychloroprene-based rubber 100 which incorporates a certain number of elements.

The panel 100 takes the form of a flexible panel as will be seen hereinbelow.

It takes the overall form of a rectangular parallelepiped of small thickness e. Parallelepiped of small thickness should be understood to mean a parallelepiped whose thickness is at least 3 times less than the width denoted I of the panel. The panel 100 also has a length denoted L.

Typically, the panels 100 have a length L of between 1 m and 2 m. They have a width I of between 40 cm and 1.60 m. The width is of course always less than the length.

Hereinbelow in the text, it is considered that, in the case where the panel has a small thickness e, it has an overall rectangular form.

The rubber panel 100 incorporates a plurality of longitudinal ducts 2 extending along the length L of the panel 100. In other words, the longitudinal ducts 2 extend in the lengthwise direction, that is to say in the direction of the length L of the panel 100.

The longitudinal ducts are spaced apart by a pitch pL of the order of 9 cm. The pitch pL can vary; it is defined by the acoustic need (special sample linked to the frequency band desired for the panel).

These ducts 2 emerge on either side of the rubber panel. They emerge more particularly on the small edges 6 of the panel which extend in the direction of the width I of the panel.

The longitudinal ducts 2 are spaced apart in the direction of the width I of the panel.

The rubber panel also incorporates a transverse duct 3 extending in the direction of the width I of the panel. This feature offers the advantage of conferring flexibility on the panel in a bending movement about an axis extending in the direction of the length L of the panel 100.

As a variant, the panel incorporates a plurality of transverse ducts 3. This makes it possible to confer greater flexibility on the panel.

This duct 3 emerges on either side of the rubber panel. It emerges more particularly on the long edges 5 of the panel which extend in the direction of the length of the panel.

The longitudinal 2 and transverse 3 ducts are cavities formed in the rubber panel 100.

These ducts 2, 3 are tubular.

In the example represented in FIG. 1, the longitudinal ducts 2 are flared at each of their ends. This feature makes it possible to incorporate, if necessary, means for processing the signals from the hydrophones in the longitudinal ducts.

In particular, they have a central tubular part 2A having a first diameter and two tubular ends 2B having a second diameter greater than the first diameter. The first diameter is between 3 cm and 5 cm and the second diameter is between 5 cm and 8 cm.

As can be seen in FIG. 2 representing a cross section of the panel of FIGS. 1 and 2 along a plane M defined by the lengthwise and widthwise directions of the acoustic panel 1, each longitudinal duct 2 receives columns 40 of hydrophones 4 spaced apart in the lengthwise L direction. These hydrophones 4 are not represented in FIG. 1 for reasons of clarity.

The hydrophones incorporated in the longitudinal ducts 2 form columns of hydrophones 40 having respective axes corresponding to the axes of the hydrophones which form it. These axes are parallel to the axes of the longitudinal ducts and preferably merge with the longitudinal duct axes in which the columns are respectively incorporated.

In the embodiment of FIGS. 1 to 3, the hydrophones 4 are received in the central part 2A of the longitudinal ducts 2.

As can be seen in FIGS. 2 and 3, the transverse duct 3 advantageously receives or conveys electrical connection cables 14 (not represented in FIG. 1 for greater clarity).

The electrical connection cables 14 are used to establish an electrical link between hydrophones 4 and electrical connection elements 15 (or electrical outputs) arranged at one or more ends of the transverse duct 3. The electrical connection elements 15 are intended to cooperate with a processing unit 16 for processing the signals from the hydrophones. Advantageously, a processing unit 16 is incorporated in the transverse duct 3 as will be seen with reference to FIG. 3. This feature makes it possible to process the signals from the hydrophones (for example, amplify them to ensure a good transmission of these signals to remote processing means outside the module 1 and possibly concentrate the amplified signals, digitize them and multiplex them to ensure a good transmission of these signals to remote processing means) directly in the module 1.

In an embodiment that is not represented in the figures of the patent application, electrical connection cables 14 are conveyed to an electrical output 15 arranged at one end of a longitudinal duct 2. This electrical output 15 can be linked to processing means for processing the signals from the hydrophones which can be incorporated or not in the module 1 or else connected to another acoustic module 1 so as to link several panels together.

The transverse duct 3 advantageously crosses the longitudinal ducts 2. This feature offers the advantage of conferring flexibility on the panel in a bending movement about an axis extending in the lengthwise direction of the module 1.

The ducts 2, 3 are filled with a liquid that is not represented. This liquid can be viscous.

The use of a liquid (fluid or viscous) enables the acoustic panel 1 to withstand the hydrostatic pressure and protects the hydrophones 4 and the electrical connection cables from damp. This design choice simplifies maintenance and preserves the capacity to upgrade the performance levels of the module (increase the number of hydrophones or incorporate new means for processing the signals originating from the hydrophones in ducts 2 or 3).

As can be seen in FIG. 3 which schematically represents, in perspective, the top right portion of the acoustic panel of FIGS. 1 and 2, the panel is provided with means for blocking the transverse 3 and longitudinal 2 ducts. These means are arranged at each end of the ducts 2, 3.

In the nonlimiting embodiment of FIG. 3, the blocking means 60 are removable blocking means. More particularly, they are plugs 7 provided with a threading 8 and the ducts are provided with a tapping 9 complementing the threading. More particularly, in the example represented, the ducts are provided with plastic inserts 10 provided with the tapping 9.

Advantageously, at least one of the plugs 7 used to block the transverse duct 3 is provided with a processing unit for processing signals from the hydrophones 4. At least one longitudinal duct 2 can also be provided with a processing unit for processing signals from the hydrophones.

The hardness of the rubber and the thickness e of the panel 100 are defined such that the acoustic module 1 exhibits a first degree of freedom in rotation about an axis extending along the length L of the panel 100 and a second degree of freedom in rotation about an axis extending along the width I of the panel 100. In other words, the acoustic module 1 exhibits degrees of freedom in bending about these two axes.

The determination of these parameters poses no problems to a person skilled in the art. It can be done easily, for example, by performing tests. The arrangement of the longitudinal and transverse ducts helps with the flexibility of the module 1, each in one direction.

Advantageously, the hardness of the rubber, the thickness of the panel 100 and the arrangement of the ducts 2, 3 are chosen such that the acoustic panel can be bent with a first minimum bending radius of between 1 m and 2.5 m about an axis extending along the length L of said panel 100 and with a second minimum bending radius of between 1 m and 2.5 m about an axis extending along the width I of said module 100.

Typically, a polychloroprene-based rubber is used that exhibits a Shore hardness of between 60 and 80 Shores A. The hardness is typically equal to approximately 70 Shores A. The Shore hardness is, here, the hardness measured using a type A durameter.

The panels 100 have a thickness of between 5 cm and 15 cm.

The presence of the transverse duct favors the bending of the panel about the axis extending along the length of the panel.

A plurality of transverse ducts 3 can be provided, spaced apart along the length of the panel 100 to favor the bending about this axis.

Because of the first degree of freedom in rotation about an axis extending along the length L, it is possible to bend the acoustic module 1 according to the invention in such a way that the columns of hydrophones that it incorporates are placed on a generatrix of a single cylinder.

It is thus possible to produce a cylindrical antenna by juxtaposing a plurality of cylindrical panels according to the invention. These panels also make it possible, by incorporating a plurality of columns of hydrophones, to create savings in terms of assembly of the acoustic antennas both in the assembly time and in the number of elements needed for the assembly.

Moreover, the use of these acoustic modules to produce cylindrical antennas does not lead to additional costs in terms of signal processing since their degree of freedom in bending makes it possible to arrange the columns of hydrophones on the generatrices of a single cylinder.

These modules can also be arranged on planar supports.

FIG. 4 shows a transverse cross section of a cylindrical antenna 11 for passive sonar according to a first embodiment of the invention.

This antenna 11 comprises a cylindrical drum 12 or pillar and a set of acoustic panels 1 according to the invention. These acoustic modules 1 bear against the drum 12. The modules 1 are arranged in such a way that the columns of hydrophones 40 that they incorporate are positioned parallel to the axis of the drum.

Advantageously, the modules 1 are arranged such that the columns of hydrophones 40 that they incorporate extend along respective axes that merge with generatrices of a single cylinder 18. In other words, the columns of hydrophones 40 extend along generatrices of a single cylinder 18. The cross section of such a cylinder is represented by broken lines in FIG. 4.

In other words, the acoustic modules 1 are arranged in such a way as to form a cylinder.

This feature is highly advantageous in terms of cost of processing of the signals from the hydrophones.

The acoustic modules 1 are held bearing against the drum 12 by conventional means which are not the subject of the invention and that a person skilled in the art easily knows how to find. It is possible, for example, to use flexible links serving as tightening bands and arranged in such a way that the acoustic modules 1 are sandwiched between the tightening bands and the drum 12.

FIG. 5 schematically shows, in perspective, a second embodiment of a cylindrical antenna 110 for passive sonar according to the invention.

The cylindrical antenna 110 has no drum as represented in FIG. 4. This antenna comprises a bottom ring 101 and a top ring 102 that are coaxial. These rings represent identical forms. The cylindrical antenna according to the first embodiment also advantageously comprises these rings.

The antenna 110 also comprises acoustic modules 1 according to the invention, only one of which is represented in FIG. 1. The acoustic modules 1 are fixed to said rings 101, 102. The fixing means used are not represented but fixing means that are conventional to a person skilled in the art will be used, such as, for example, screws.

As can be seen in FIG. 1, modules 1 advantageously comprise thermoformed plastic (or metal) inserts 17 making it possible to simplify their assembly on rigid structures such as rings. FIG. 1 shows only inserts protruding on a small edge 6 of the panel 100, but inserts protruding on the opposite small edge and on the large edges 5 of the panel are advantageously provided. In other words, inserts are provided that protrude over the thickness of the panel 100.

The acoustic modules 1 are arranged to form, between the two rings 101, 102, a tubular self-supporting drum, the modules extending in the direction of the length L between the bottom ring 101 and the top ring 102.

Advantageously, the acoustic modules 1 are arranged such that the columns of hydrophones 40 that they incorporate extend along respective axes that are merged with the generatrices of a single cylinder 180 represented by broken lines. In other words, the acoustic panels are arranged in such a way as to form a cylindrical drum.

Typically, the cylindrical antennas have a radius of between 1 m and 2.5 m. This is the radius of the cylinder on the generatrices of which the columns of hydrophone 40 are positioned.

As seen previously, the hardness of the rubber, the thickness and the arrangement of the transverse ducts are chosen such that the acoustic panel can be bent with a first minimum bending radius of between 1 m and 2.5 m about an axis extending along the length L of said panel 1. In this way, the panel can be used to produce cylindrical antennas of different radii provided that they are at least equal to the first minimum bending radius.

The presence of the first degree of bending also makes it possible to produce tubular antennas that are not cylindrical, that is to say with a noncircular base with generatrices that are parallel to an axis extending along the length L of the panel 1. These antennas are obtained by positioning the modules 1 against a tubular drum or else between two rings just like the tubular antennas. The modules 1 are positioned in such a way that the columns 40 extend along said generatrices.

The second degree of freedom in rotation about an axis extending in the direction of the width I of the module 1 makes it possible to use the acoustic panels to produce acoustic flank antennas for receiving submarine waves. Flank antennas should be understood to mean antennas installed on the flanks of the submarines.

This feature is highly advantageous in terms of cost, because it makes it possible to provide a single acoustic module 1 to produce cylindrical antennas and flank antennas.

FIG. 6 shows a flank antenna 200 according to the invention.

This antenna 200 comprises a succession of acoustic modules 1 according to the invention which are mounted bearing against the hull 201 of a submarine 202. The acoustic panels 1 are more particularly mounted on a flank of the submarine 202.

The long edges 5 of two adjacent panels 1 face or are advantageously attached to one another as represented in FIG. 6.

The acoustic modules 1 are installed in such a way as to extend along their width I substantially parallel to the axis x of the submarine.

The wall 201 of the submarine 202 is then dished between the two small edges 6 of each of the modules 1 which necessitates a degree of freedom in bending of these panels 1 about an axis extending along their width.

The modules 1 are mounted on the wall 201 of the submarine by means of conventional mounting means as a person skilled in the art such as mounting bands arranged in such a way as to extend along the length L of the panels and such that the modules 1 are sandwiched between the bands and the wall of the submarine. Ducts can be provided that extend along the thickness of the panels and receive inserts passing through the panel from side to side through its thickness. The link between the modules 1 and the wall 201 is advantageously established by means of studs passing into the inserts.

The same mounting means can be used for the tubular antennas presented previously and the antennas presented hereinbelow.

Because of the second degree of freedom in bending, the modules 1 can be installed on submarines that have different radii of curvature provided that they have radii of curvature at least equal to the second minimum bending radius.

Moreover, because of the two degrees of freedom in bending, the modules 1 can be installed on submarines that have variable radii.

These degrees of freedom also make it possible to produce tapered tubular antennas with a base that is circular or not by means of these modules. In the tapered antennas with circular base, the generatrices are positioned on a cone. These antennas are obtained by positioning the modules 1 on a tapered drum or else between two rings just like the tubular antennas. The modules 1 are positioned in such a way that the columns 40 extend along said generatrices.

Moreover, as represented in FIG. 8, the submarines 302 conventionally comprise a hull 301 comprising a mouth 303 in the front part of the submarine. The mouth 303 is a cavity emerging in the front part of the submarine 302.

The antennas for passive sonars are conventionally positioned in the mouth 303 of the submarine. A fairing is then added to the hull of the submarine and this fairing blocks the mouth 3 and gives the submarine a hydrodynamic form. FIG. 3 shows a submarine equipped with an antenna 300 formed by a juxtaposition of modules 1 according to the invention which block the mouth 303. The modules 1 form part of the fairing making it possible to give the submarine a hydrodynamic form. This embodiment makes it possible to use the space provided by the mouth for other purposes. It can be obtained by virtue of the presence of the two degrees of freedom in bending which make it possible to make the modules 1 adopt complex forms.

Another subject of the invention is an antenna for passive sonar in which the acoustic modules are fixed onto the front part of the hull of the submarine. Because the modules 1 can be made to adopt complex forms, it is no longer necessary to produce mouths in the submarine which significantly reduces the costs of production of the submarine.

In these latter two cases, the geometry of the panel is then optimized to allow for the curvature of installation, which necessitates bending flexibility, while exhibiting a sufficient stiffness to withstand the navigation conditions (submarine advance pressure, bow wave, heavy sea, etc.).

FIG. 7A shows a column of hydrophones 40 extending along an axis y corresponding to the axis of the hydrophones 4 that it comprises. FIG. 7B shows an enlarged view of the content of the bubble represented in FIG. 7A.

The hydrophones 4 are mounted in longitudinal ducts so as to form columns of hydrophones 40 extending along the axis y of the hydrophones which form it. They are mounted by mounting means that are conventional according to a person skilled in the art. In the example represented in FIGS. 7A, 7B, the hydrophones are provided with positioning fins 41 provided with orifices 44 into which are threaded rigid rods 42. The hydrophones 4 are fixed to the rods 42 by means of fixing means 43 in such a way as to be spaced apart by a pitch P along the axis y.

1. An acoustic module for an acoustic antenna for receiving submarine waves, produced in the form of a panel of polychloroprene-based rubber, incorporating a plurality of longitudinal tubular ducts extending along the length of the rubber panel and being spaced apart along the width of the rubber panel, said longitudinal ducts receiving columns of hydrophones spaced apart lengthwise, said rubber panel also incorporating at least one transverse duct extending along the width of said rubber panel, said longitudinal and transverse ducts being filled with a fluid and said acoustic panel (1) being provided with means for blocking said ducts in a seal-tight manner, the hardness of the rubber and the thickness of the panel being chosen such that the acoustic module exhibits a first degree of freedom in bending about an axis extending lengthwise and a second degree of freedom in bending about an axis extending widthwise.

2. The acoustic module as claimed in claim 1, in which the transverse duct crosses the longitudinal ducts.

3. The acoustic module as claimed in claim 1, in which said ducts are filled with a liquid.

4. The acoustic module as claimed in claim 1, in which the transverse duct conveys electrical connection cables used to establish an electrical link between hydrophones and electrical connection elements arranged at an end of the transverse duct, the electrical connection elements being intended to cooperate with a processing unit for processing the signals from the hydrophones.

5. The acoustic module as claimed in claim 1, incorporating a processing unit for processing the signals from the hydrophones at one end of one of said ducts.

6. The acoustic module as claimed in claim 1, in which the hardness of the rubber, the thickness of the panel and the arrangement of the ducts are chosen such that the acoustic panel can be bent with a first minimum bending radius of between 1 m and 2.5 m about an axis extending along the length of said panel and with a second minimum bending radius of between 1 m and 2.5 m about an axis extending along the width of the panel.

7. The acoustic module as claimed in claim 1, in which the rubber exhibits a Shore hardness of between 60 and 80 Shores A.

8. The acoustic module as claimed in claim 1, in which the panel has a thickness of between 5 cm and 15 cm.

9. An acoustic antenna for receiving submarine waves for passive sonar comprising a set of acoustic modules as claimed in claim 1.

10. The acoustic antenna as claimed in claim 1, said antenna being tubular.

11. The acoustic antenna as claimed in the preceding claim claim 1, said antenna being tapered.

12. The acoustic antenna as claimed in claim 10, comprising a drum and in which the acoustic modules bear against said drum.

13. The acoustic antenna as claimed in claim 10, comprising a bottom ring and a top ring that are coaxial, and in which the acoustic modules are fixed to the bottom and top rings and are arranged in such a way as to form, between the two rings, a tubular self-supporting drum, the panels extending lengthwise between the bottom ring and the top ring.

14. The acoustic antenna as claimed in claim 10, said antenna being cylindrical.

15. The acoustic antenna as claimed in claim 14, in which the acoustic modules are arranged in such a way that the columns of hydrophones extend along respective generatrices of a single cylinder.

16. The acoustic antenna as claimed in claim 9, in which the acoustic modules are fixed onto the front part of the hull of a submarine.

17. The acoustic antenna as claimed in claim 9, in which the acoustic modules block a mouth formed in the front part of the hull of a submarine.

18. An acoustic antenna for receiving submarine waves, comprising a succession of acoustic modules as claimed in claim 1, mounted to bear against a hull of a submarine, said acoustic modules being arranged in such a way as to extend according to their width substantially parallel to the axis of the submarine.
